(19) United States
(12) Patent Application Publication
(10) Pub. No.: US 2009/0308349 A1
(43) Pub. Date: Dec. 17, 2009

(54) Throttle body with throttle valve

(76) Inventor: Helga Apel, Nordkirchen (DE)

Correspondence Address: Karl F. Milde, Jr., Esq.;Milde & Hoffberg, L.L.P, Suite 460, 10 Bank Street, White Plains, NY, 10606, US

(21) Appl. No.: 12/456,112

(22) Filed: Jun. 11, 2009

(30) Foreign Application Priority Data
Jun. 11, 2008 (DE) 10 2008 027 888.2
Jan. 24, 2009 (DE) 20 2009 000 926.2

(51) Int. Cl. F02D 9/08

(52) U.S. Cl. 123/337

(57) ABSTRACT

A throttle valve device includes at least one throttle body (1, 2, 3), a throttle valve (4) and a throttle valve shaft (5), with which the throttle valve (4) is adjustably arranged in the throttle body (1, 2, 3). In order for these parts to be able to function more trouble free and be manufactured at a more favorable price, the throttle body comprises an inner cylinder (1) made of a hard, smooth material around which at least partially an outer cylinder (2) made of thermoplastics is formed.

The invention relates to a throttle valve device consisting of at least one throttle body, a throttle valve and a throttle valve shaft that is used to position the throttle valve in an adjustable manner in the throttle body, as well as a method for manufacturing the same.

A throttle valve device of the type mentioned above is known from DE 195 49 509 A1. It consists of a housing and a throttle valve. The throttle valve is adjustably positioned via a throttle valve shaft in the throttle valve housing and controls the air flow rate to a vehicle engine.

One disadvantage is that the housing and the throttle valve are made of aluminum requiring finishing work. In finishing, a high degree of fitting accuracy must be observed. This translates into high expenses. An additional disadvantage is that the throttle valve can seize in the throttle valve housing. At low temperatures, there is an additional risk of a freeze-up of the throttle valve.

Know from EP 11 54 240 A2 is a rotary actuator transducer device, where a sensor unit is connected to an output unit through a lead frame element with at least one grid rail. The disadvantage is that the components for switching the sensor unit must be placed individually onto the lead frame element.

Known from DE 10 2006 030 133 A1 is a module unit that includes a lead frame and a sub area on which the die is located. Components are arranged on the lead conductor strands. An insulator is designed such that several conductor strands and the die are embedded in it. An additional insulator encapsulates the components.

A partially two-layered body as a throttle body is known from EP 1 554 099.

It is the objective to develop a throttle valve device of the aforementioned prior art such that its parts can function more trouble free and can be manufactured at a more favorable price.

According to the invention, this objective is achieved in that the throttle body consists of an inner cylinder made of a hard, smooth material, around which, at least partially, an outer cylinder made of a thermoplastic is formed.

The material can be a non-metallic material. The selection can be made of thermosets or ceramic materials.

The material can be a metallic material. The selection can be made from drawn aluminum, magnesium or an extruded material.

The advantages are primarily in that finishing work as needed with cast materials is not required in this case. This reduces the manufacturing costs significantly while it increases the fitting accuracy to the same degree.

Preferably, the throttle body consists of an inner cylinder made of thermosets or ceramics around which, at least partially, an outer cylinder made of thermoplastics is formed, whereby the throttle valve is made of a central thermoset element, which is at least partially surrounded by a thermoplastic enclosure body.

In particular, the solutions have in common that the main components of the throttle valve device have a solid body as its carrying element that is made of thermosets or of ceramics. Thermosets or ceramics, respectively are not sensitive to fuel mixtures. One significant advantage is that essentially no finishing work is required. Such cylinder elements can also be drawn as precision tubes.

In particular if thermosets are used, the bodies made of this material exhibit sufficiently high temperature resistance and little thermal shrinkage. Furthermore, the absorption of humidity is very small and low injection pressure is required for forming. To protect it, in particular, against hard impacts, the body is surrounded by an outer cylinder made of an elastic thermoplastic.

The material of the throttle valve can include a center body element made of thermosets that can be surrounded entirely or at least in part by the thermoplastic enclosure body.

At least in part, the inner cylinder can be provided with a flat section. The flat section prevents, in particular, turning of the inner cylinder in the outer cylinder.

At least in part, the inner cylinder can be surrounded by a finned section. This prevents sliding inside the outer cylinder.

At least in part, the inner cylinder can be provided with an inner coating. This inner coating can be made partially of PTFE (trade name Teflon) at least in the area of the throttle valve contacts. This effectively prevents seizing of the throttle valve.

The throttle valve shaft can exhibit at least one catch element that can be used to connect the throttle valve shaft with the throttle valve. The catch elements ensure that an actuating force that may originate from an actuating motor indeed results in the movement of the throttle valve. This prevents turning of the throttle valve shaft in the throttle valve alone. The catch element can be a catch body. However, the catch elements can also be designed as toothed elements.

Arranged on the center body element of the throttle valve can be a thermoplastic inner body as a thermoplastic enclosure body. It is also possible that a thermoplastic outer cylinder is arranged on the center body element of the throttle valve—opposite the thermoplastic inner body. Thus, the center body is enclosed like the filling of a sandwich.

The throttle valve shaft can be supported by a sliding bearing and/or a ball bearing. It is possible that the throttle valve shaft is supported by
two sliding bearings on opposite sides,
two ball bearings on opposite sides,
a sliding bearing and on the opposite side a ball bearing.

Molded to the outer cylinder made of thermoplastics can be a housing bottom. Located in the housing bottom can be a measuring and relocating device with a sensor unit and an output unit connected to each other through a connecting grid element that exhibits at least one grid rail.

The sensor unit may exhibit a module unit with an integrated circuit located on a subarea of a conducting board and encapsulated by an injection-molded object. Using conductor strands, the integrated circuit can be connected with components that can be encapsulated by additional injection-molded objects. The connection can be made through bonding wires or by welding.

The sensor unit may exhibit a double module unit at which a conductive board can exhibit an upper and a lower subarea,
whereby a first integrated circuit can be located on the upper subarea and can be encapsulated by a first injection-molded object,
whereby the first integrated circuits can be connected to first components, which can be encapsulated by a second injection-molded object, via the first conductor strands,
whereby a second integrated circuit can be located on the lower subarea and encapsulated by a third injection-molded object, and
whereby the second integrated circuit can be connected to second components, which can be encapsulated by a fourth injection-molded object, via second conductor strands.

Here too, the connection can be established by bonding or welding.

Both the module and the double module unit ensure that the integrated circuit of the sensor can already be pre-populated. With this, the advantage is, in particular, that pre-populating is done on the band, thus significantly saving manufacturing costs. Furthermore, with almost the same space demand for two integrated circuits, one rail can be saved with the double module unit.

The inner cylinder can be split longitudinally and/or perpendicularly. It can exhibit a left and a right half. The inner cylinder can also be split into an upper and a lower throttle body portion. The split can be carried out in the subarea of the throttle valve shaft.

With a cross split, this area is located at the level of the throttle valve shaft, with a cross split in the longitudinal direction of the throttle valve shaft, such that in both cases the throttle valve shaft together with its bearings and the like are placed fully assembled between the two halves.

The sliding and/or ball bearings can be at least partially enclosed through bearing enclosure areas of the outer cylinder made of thermoplastics.

The separation of the inner cylinder of the throttle body simplifies the assembly of the throttle valve shaft with its bearings because the bearings simply need to be placed in the respective provided bearing recesses, both inner cylinder components together can be extrusion coated with a thermoplastic cylinder and can be defined and sealed through bearing enclosure areas using the bearing enclosure areas. In addition, the invention also relates to a method for manufacturing a throttle valve device, comprising the following processing steps:

a) forming of an upper and lower partial inner cylinder made of a hard, smooth material with at least one flat section and at least one fin element;
b) putting sliding and/or ball bearings onto the throttle valve shaft;
c) placing the upper and the lower partial inner cylinder and enclosing the sliding and/or ball bearings with both partial inner cylinders;
d) extrusion-coating of the upper and lower partial inner cylinder through an outer cylinder made of thermoplastics and at least partial enclosing of the sliding and/or ball bearings with bearing enclosure areas.

Additionally, the invention relates to a method for manufacturing a throttle valve device, characterized by the use of thermosets such that

a) two inner partial cylinders made of thermosets are formed with at least one flat section and at least one fin element,
b) the sliding and/or ball bearings are put onto the throttle valve shaft,
c) the two partial inner cylinders are placed together and the sliding and/or ball bearings of the throttle valve shaft placed between them are enclosed by the two partial inner cylinders,
d) the two partial inner cylinders are surrounded by an outer cylinder made of thermoplastics through extrusion molding and sliding and/or ball bearings are at least partially enclosed with bearing enclosure areas.

The use of thermosets leads to an entirely new way of manufacturing the throttle valve device. Both half shells receive their final shape without much finishing work. The throttle valve shaft can be placed between them with its bearings. Cumbersome “threading” becomes unnecessary. Finally, the outer shell made of thermoplastics holds everything together. The manufacturing effort is reduced to about 30% compared to throttle valve devices made of cast aluminum.

Especially the outer shell provides a tight cylinder body in which the throttle valve can move.

When forming the outer hollow cylinder body, a bottom part of the housing can be molded to it.

Externally, the throttle valve device looks like the conventional ones and thus achieves confidence and acceptance by the manufacturer and the customer.

Following, the invention is described in greater detail based on the drawing, of which

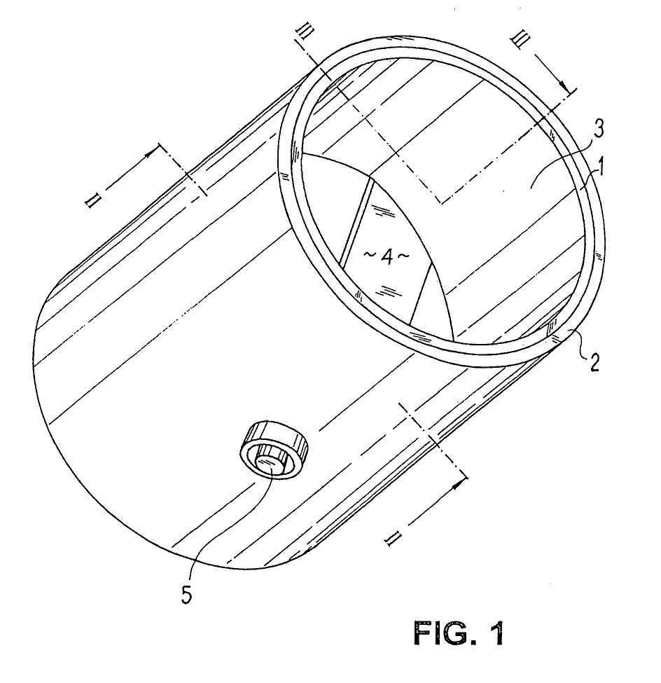

FIG. 1 is a schematic, perspective view of a throttle valve device,

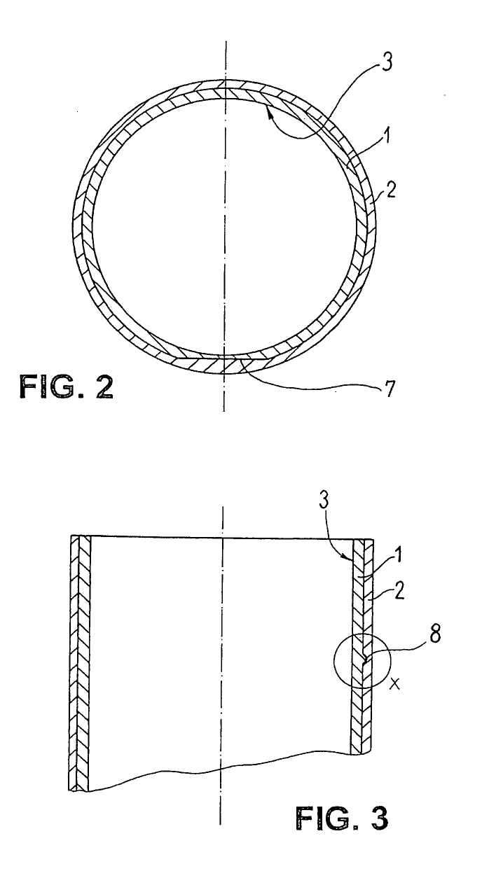

FIG. 2 is a schematic sectional view of a throttle body of a throttle valve device along the line II-II according to FIG. 1,

FIG. 3 is a schematic sectional view of a throttle body of a throttle valve device along the line III-III according to FIG. 1,

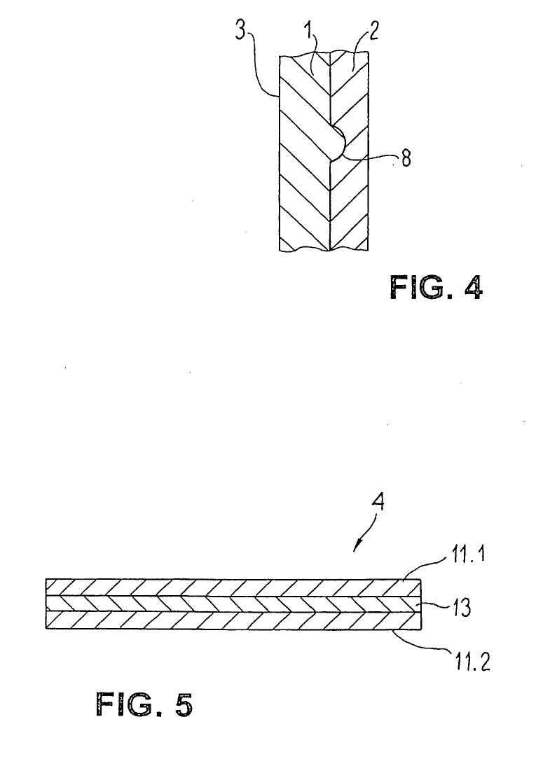

FIG. 4 is a magnified sectional view of a section X of a throttle body according to FIG. 3,

FIG. 5 is a magnified, sectional, schematic view of a throttle valve of a throttle valve device according to FIG. 1,

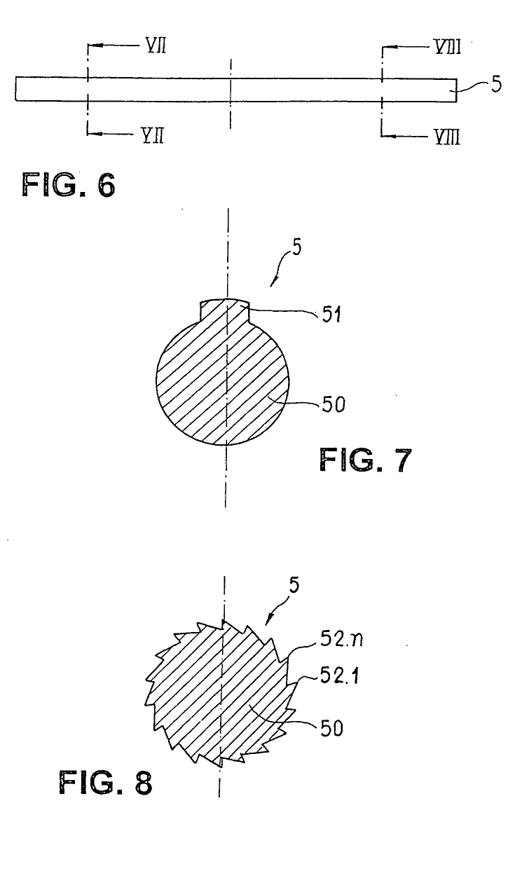

FIG. 6 is a schematic view of a throttle valve shaft of a throttle valve device according to FIG. 1,

FIGS. 7 and 8 show catch elements for a throttle valve shaft according to FIG. 6,

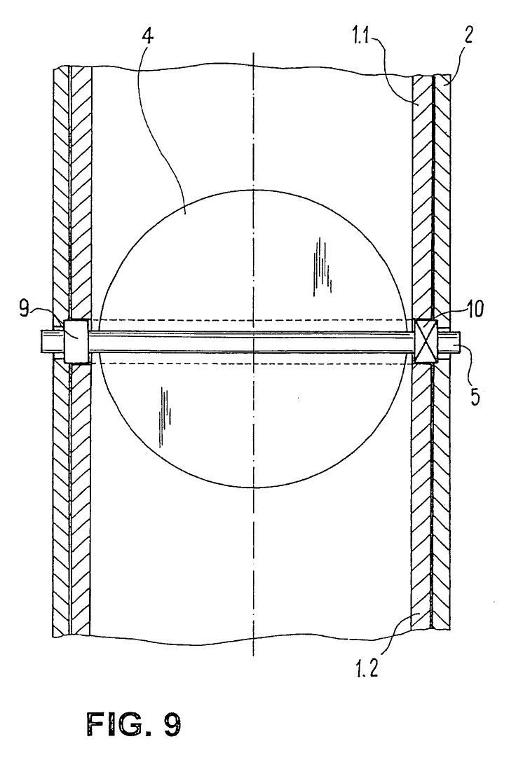

FIG. 9 is a schematic, sectional view of an additional embodiment of a cylinder body of a throttle valve device according to FIG. 1,

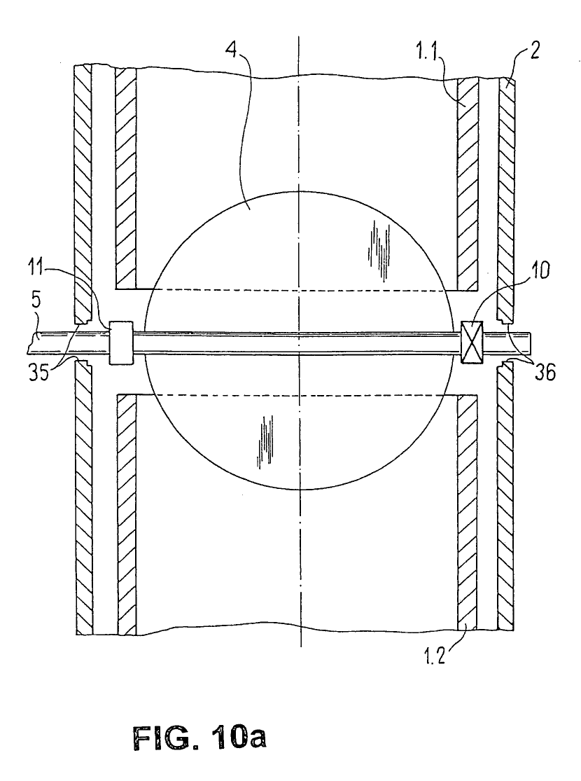

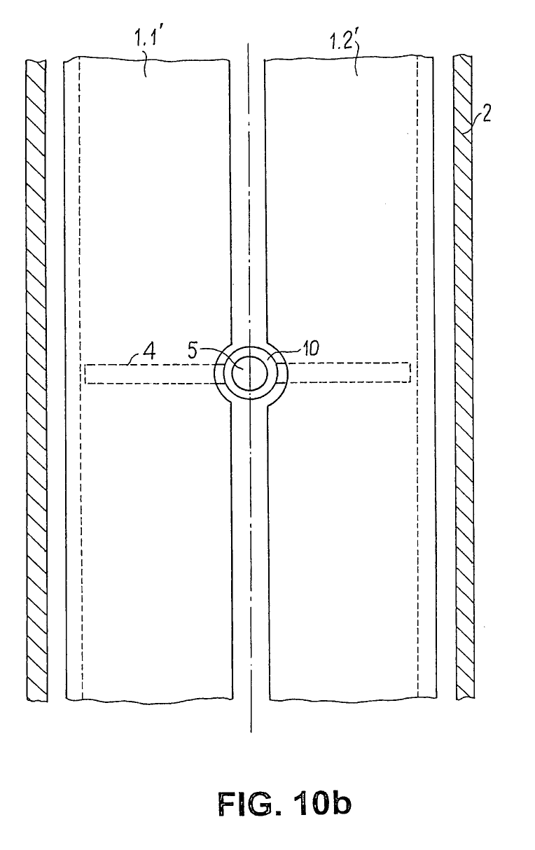

FIG. 10a is a schematic, exploded view of a throttle body according to FIG. 9 with a cross-split inner cylinder,

FIG. 10b is a schematic, exploded view of a throttle body according to FIG. 9 with a longitudinally split inner cylinder,

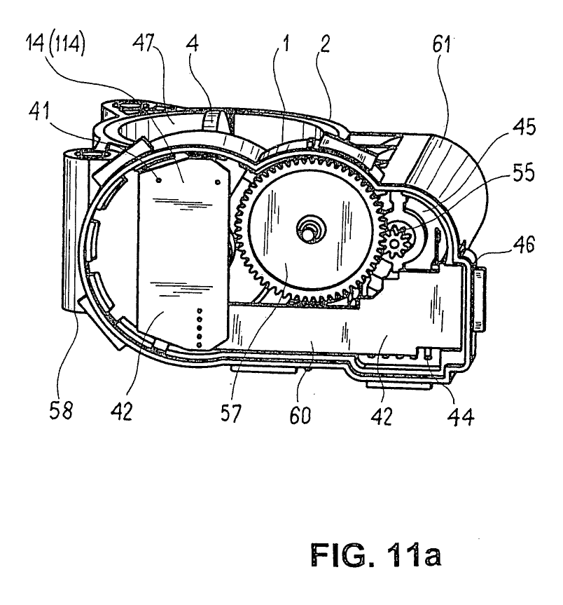

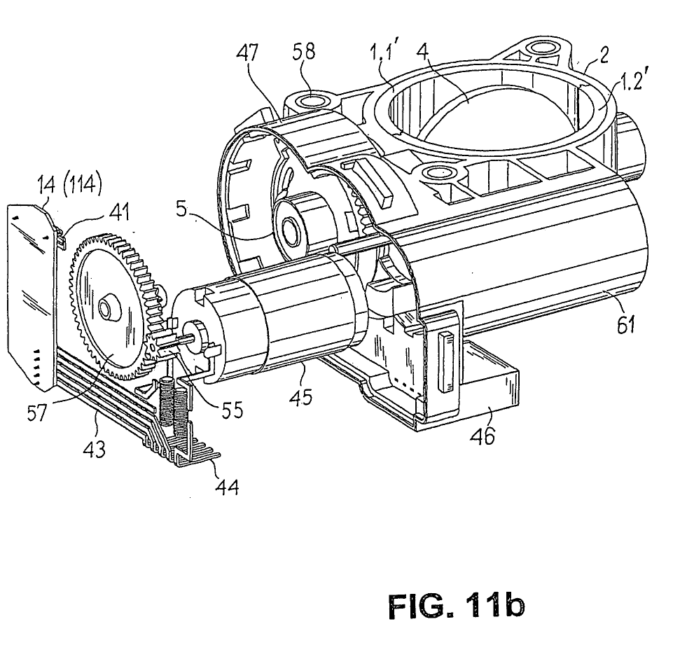

FIG. 11a is a schematic view of a throttle body of a throttle valve device according to FIGS. 1 to 9 with a molded-on lower housing part and a measuring and control unit,

FIG. 11b is a schematic, exploded view of a throttle body of a throttle valve device according to FIG. 11a,

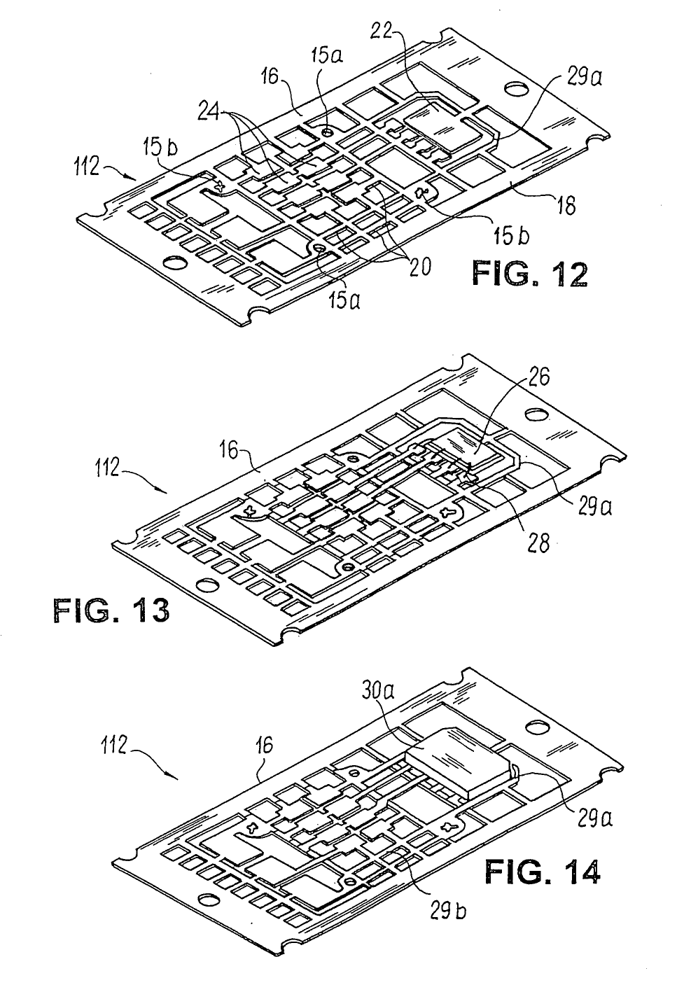

FIGS. 12 to 19 are schematic, perspective views of a first embodiment of an element after processing steps, and

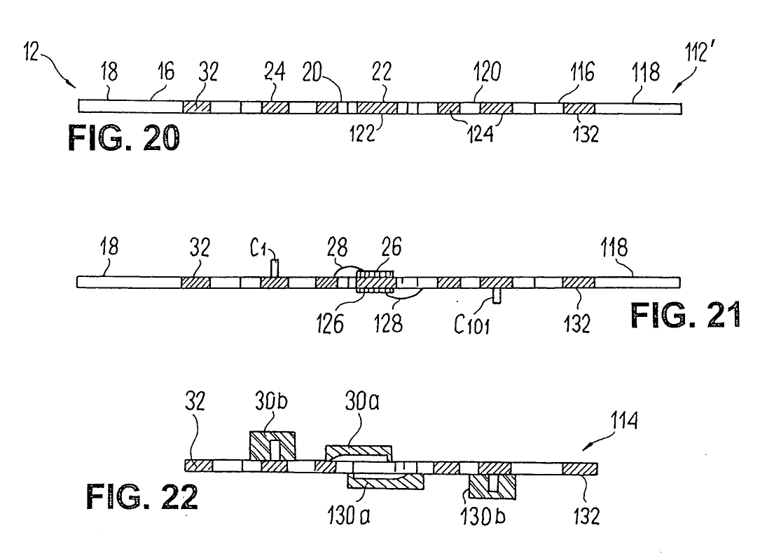

FIGS. 20 to 22 are schematic, sectional views of a second embodiment of an element after processing steps.

In the engine compartment, a throttle valve device is exposed to temperature fluctuations, in particular to heat, fuel mixtures and mechanical stress. The throttle valve device described below is equipped and designed for such loads.

FIGS. 1 to 4 show a hollow cylinder 100 that represents the starting element for a throttle valve device according to the invention. The hollow cylinder 100 includes an inner cylinder 1 made of thermosets and is surrounded by an outer cylinder 2 made of thermoplastics. A thermally cured epoxy resin with a high thermal resistance and with a 25% in weight fiberglass filling is used as the thermoset. Other thermosets, in particular other epoxy resins can be used as well. In general, thermosets are synthetics that are very stable, have a low tendency to distortion but are very sensitive to impact. Long curing times are required until the shape is ready. First, the inner cylinder 1 is made with the required wall thickness of molding compounds using pressing, transfer molding or injection molding methods, and is re-worked if required.

To prevent seizing of the throttle valve 4, the inner wall of the inner cylinder 11 is provided with a Teflon coating 3 as shown in FIG. 2. It is also possible to add friction-reducing fillers to the thermosets of the inner body.

The outer cylinder 2 is made of thermoplastics and is, thus, more elastic compared to the inner cylinder 1. It protects the delicate inner body from damage. The outer cylinder 2 made of thermoplastics is placed around the inner cylinder 1 using an essentially known extrusion coating method. Principally, hollow bodies made of thermoplastics can be produced using an injection molding method or other essentially known methods.

From the group of technical thermoplastics, polyamides have become popular with many users due to their good machining properties, their high dimensional stability under heat and their brilliance. Composite materials made of organic polymers such as polyamides with flake-like (nanoscale) fillers consisting of nano materials, in particular layer-like silicates (phyllosilicates) can be used as well. The thermoplastic materials distinguish themselves through their great rigidity. Aside from the improvement of the rigidity, the toughness is reduced by the addition of phyllosilicates. Aside from polyamides (PA) other suitable synthetics are PBTB (polybutylene terephtalate), PPS (polyphenylene sulfide), POM (Polyoxymethylene), aliphatic polyketones, PVDF, PE (polyethylene), e.g., HDPE (high density polyethylene), PP (polypropylene), TEEE, TPE, PPA, PEEK (polyetheretherketone).

Inner and outer cylinders 1 and 2 are mechanically secured against each other. For example, the inner cylinder 1 receives an at least partially extending flat section 7. This section prevents a rotation of the inner cylinder 1 in the outer cylinder 2 as shown in FIG. 2. To avoid sliding of the inner cylinder in the outer cylinder, the inner cylinder 1 is provided with an—at least partially surrounding—fin element 8 as shown in FIGS. 3 and 4.

The hollow cylinder 100 processed in this manner forms a throttle body for the throttle valve 4 to be arranged in its interior and together with the throttle valve shaft 5 rotationally mounted inside the throttle body. Selected as the materials for the throttle valve 4 are also synthetics made of thermosets and thermoplastics as the main components. As shown in FIG. 5, the throttle valve 4 exhibits a thermoset center body 13 enclosed by a thermoplastic inner and outer cylinder 11, 12 in a sandwich-like manner.

According to FIG. 6, the throttle valve shaft 5, exhibits catch elements. In FIG. 7, a catch body 51 is molded to a shaft body 50 of the throttle valve shaft. According to FIG. 8, toothed elements 52.1, . . . , 52.n are molded to the shaft body 50. When the throttle valve shaft 5 is slid into the throttle valve 4, the catch elements will provide a friction-locked fit. Rotational movements that are delivered by a throttle valve actuating motor 45 are directly converted to a direct adjustment of the throttle valve 4.

Using a laser weld connection or an extrusion coating method, the throttle valve shaft 5 and the throttle valve 4 can be connected to each other or produced integrally.

FIGS. 9, 10a and 10b show additional embodiments of the throttle body. Here, the inner cylinder 1 consists of an upper and a lower partial cylinder 1.1, 1.2 or a left and right partial cylinder 1.1′, 1.2′, respectively.

Both partial cylinders 1.1, 1.2 or 1.1′, 1.2′, respectively, can exhibit at least one flat section and/or at least one fin body.

As shown in FIG. 10a, the separation of the inner cylinder into the upper partial cylinder 1.1 and the lower partial cylinder 1.2 is carried out at the level of the throttle valve shaft 5. When forming the two partial cylinders 1.1, 1.2, the partial recesses for a sliding and/or ball bearing for the throttle valve shaft 5 are formed at the same time. If both partial bodies 1.1, 1.2 are available, the throttle valve shaft 5 with the bearings is placed between them and thereafter both partial bodies are connected and then a thermoplastic outer cylinder is extrusion coated around it. When forming the outer cylinder 2, bearing enclosure areas 35, 36 are formed at the same time. The outer cylinder holds and seals the two partial cylinders 1.1, 1.2 together. The bearing enclosure areas hold both bearings in place and position the throttle valve shaft 5.

The separation of the inner cylinder into the left partial cylinder 1.1′ and the right partial cylinder 1.2′, on the other hand, is carried out according to FIG. 10a in the plane of the throttle valve shaft 5 as two half shells. When forming the two partial cylinders 1.1′, 1.2′, here too the partial recesses for a sliding and/or ball bearing for the throttle valve shaft 5 are formed at the same time. When both partial bodies 1.1′, 1.2′ are formed, the throttle valve shaft 5 with the bearings is placed between them and thereafter both partial bodies are connected and then a thermoplastic outer cylinder 2 is extrusion coated around it. When forming the outer cylinder 2, bearing enclosure areas 35, 36 are formed at the same time as well. The outer cylinder holds and seals the two partial cylinders 1.1′, 1.2′ together. The bearing enclosure areas then hold both bearings in place and position the throttle valve shaft 5.

A bottom part of a housing 47 is molded to the outer cylinder 2 as shown in FIGS. 11a and 11b. A measuring and relocating device comprising a sensor unit 14, 41, 114 and an output unit 44, 45 that are connected by a connecting element 42 are housed in the housing 47. The connecting grid element 42 consists of several grid rails 43. The number of grid rails is determined by the plurality of the necessary connections. The grid rails are at least partially formed into a synthetic material that preferably is a thermoplastic material (cf. FIG. 11a). To compensate for the material expansions caused by the temperature changes, the connection element 42 can include an expansion bend.

The output unit consists of a connector element 44 and the aforementioned throttle valve actuator motor 45, as can be seen in particular in FIG. 11b. The connector contacts of the connector element 44 are surrounded by a connector housing 46. The throttle valve motor 46 is surrounded by a motor housing 61. Located between the throttle valve shaft 5 and the throttle valve motor 46 is a gear 55, 57 with a small toothed wheel 55 located at the motor 46 and a large toothed wheel 57 that is in contact with the shaft 5.

The sensor unit comprises a sensor unit 41 and a module or double module unit 14, 114.

FIGS. 11a and 11b show an inductive sensor that works according to the sensor pad method as the sensor unit. Other sensor elements may be used in place of the inductive sensor. The sensor element 41 comprises a module or double module unit.

The advantage of the described measuring and relocating device is that its parts can be installed in a pre-assembled manner in the bottom part of the housing 47. The connector element 44, or the motor 45, respectively, are placed in the respective housings 46, 61. Thereafter, they are held in place using a fastening element. A cover is then placed on the housing 47 and held in place using a retaining pin or a clamp. A machine element 58 can be used as a support for the entire throttle valve device.

Design and implementation of the module unit 14 or the double module unit 114, respectively, are determined by the fitness for the respective use.

As shown in particular in FIG. 12, grids 16 for assembly units 112 are punched in succession from thin metal strips with a thickness of 0.1 to 1.0 mm, preferably 0.18 to 0.2 mm. The metal strip is made of copper, copper-containing alloys, nickel silver, brass or bronze.

Every lead frame 16 exhibits a subarea 22, a plurality of conductor strands 20 and contact areas 24 that are surrounded by an all-around frame 18. The area, also named die pad, is at least partially enclosed by a frame 29a, also called danbar. Position holes 15a or fastening openings 15b are provided for subsequent positioning and fastening. In addition, catch or centering holes are punched out.

Then, an integrated circuit 26 is placed on the subarea 22 as shown in FIG. 13. Here, the integrated circuit includes the hall element or another sensor and the respective central processing unit and in this case is realized as an ASIC (Application Specific Integrated Circuit). Using the bond wires 28, the ASIC 26 is connected to the conductor strands of the subarea 22.

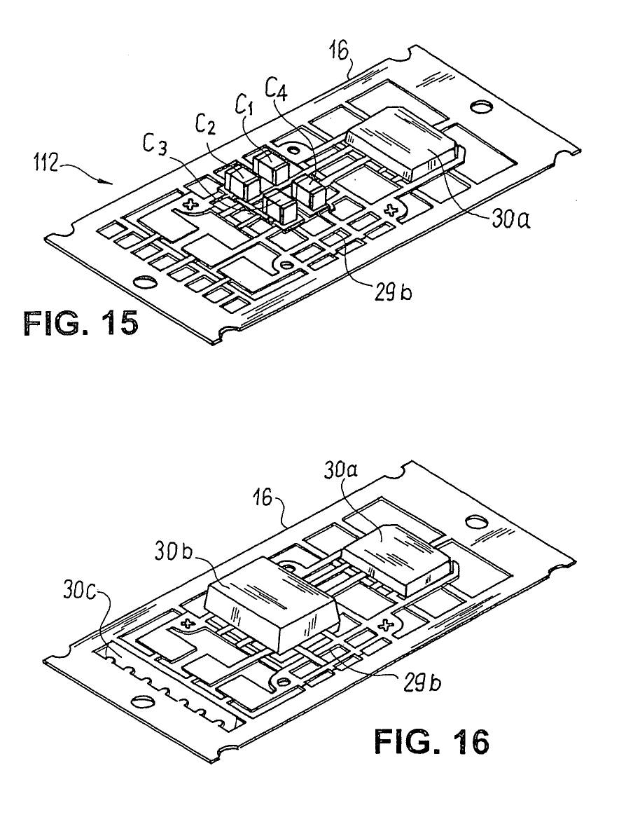

An injection-molded object 30a made of thermosets, here epoxy resin, surrounds, at least in part, the ASIC 26, the bond wires 28 and the conductor strands 20 as shown in FIG. 14. During injection, the frame 29a seals the injection mold and prevents the plastic from dissipating between the conductor strands. Thereafter, discrete components C1, C2, C3, C4 are placed on the contact areas 24 (cf. FIG. 15). They serve as the circuits of the ASIC 26. The components realized as capacitors C1, C2, C3, C4 are encapsulated with an injection molded body 30b that is made of thermosets as well (16). A frame 29b plays the same role as the frame 29a when forming the injection molded body 30a. Forming of all injection molded bodies can be done at the same time.

The support body 30c is injected along with the injection molded body 30b and embeds a conductor structure consisting of several parallel webs. This extrusion coating will have a special task when testing the almost finished module unit.

As FIG. 19 shows, the short circuits of all non-ground-contacts are removed with the sensor unit 14 not yet separated from the lead frame. The sensor unit 14 comprises three contact areas 32, two of which as well as the associated conductor webs are electrically isolated from the lead frame 16. The ground contact and the associated conductor webs continue to be connected with the lead frame 16. Additionally, a mechanical connection is established via the support body 30c. To this end, the parallel webs that are embedded in the support body are separated alternating on the sides of the lead frame 16 and on the sides of the parts of the lead frame 16 that are connected to the contact areas 32. As a result, there are no more electrical connections between the lead frame 16 and the two contact areas 32 that do not serve as ground contact.

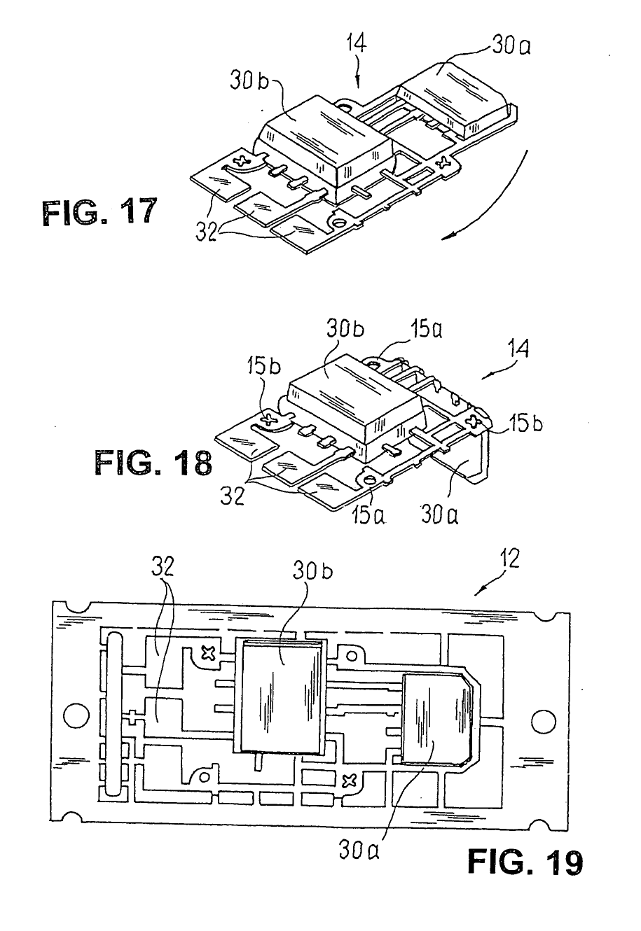

Once the test is finished, all frames 18, 29a and 29b and remaining jumpers between the conductor strands 20 are removed by punching. This punching procedure produces the final electrical circuit. The support functions of terminals and conductor connections are taken over by the injection molded bodies 30a and 30b. The finished module unit 14, consisting of the ASIC or another integrated circuit and the components for the protective circuit and the like are then available with the respective housings as shown in FIG. 17.

If the module is to have only one housing, the ASICs can be pre-encapsulated together with the bond wires and components in one working housing. The described final circuit cut is then carried out and the entire formation is surrounded by an injection molded housing.

In a final step, the module unit 14 is processed by bending the injection molded body 30a with the ASIC 26 as shown in FIG. 18. The thin remaining conductor strands 20 of the thin lead frame 16 allow for a problem-free bending procedure. Now, the module unit 14 has a remaining length of only about 20 to 40 mm and can be fastened to the connection grid element 42 and at the same time positioned functionally.

FIGS. 20 to 22 show the processing steps for a more powerful sensor unit (double module unit) 114.

As shown in particular in FIG. 20, grids 116 for assembly units 112′ are punched in succession from thin metal strips with a thickness of 0.1 to 1.0 mm, preferably 0.18 to 0.2 mm. Here too, the metal strip is made of copper, copper-containing alloys, nickel silver, brass or bronze.

Each lead frame 116 exhibits subareas 22, 122, a plurality of conductor strands 20, 120 and contact areas 24, 124 that are surrounded by all-around frames 18, 118. The subareas are at least partially enclosed by frames, also called danbar. Both subareas are part of a conductive board. Position holes 15a or fastening openings 15b or the like are provided for subsequent positioning and fastening. In contrast to FIG. 12, the lead frame 116 consists of the already described lead frame 16, which is followed essentially from the subarea 22 in an essentially similar configuration.

Then, an integrated circuit 26 is placed on the subarea 22 as shown in FIG. 21. Here, the integrated circuit includes the sensor element and the respective processing unit and is realized as an ASIC. Using the bond wires 28, the ASIC 26 is connected to the conductor strands in front of the subarea 22. On the opposite side, an additional integrated circuit 126 is glued to the subarea 122. Bond wires 128 connect the ASIC 126 to the conductor strands 120. Thereafter, discrete components C1, C2, C3, C4 are placed on the contact areas 24 and discrete components C101 are placed on the contact areas 124. The components, e.g., capacitors C1, . . . , C4 serve as circuits of the ASIC 26 and the capacitors C101, . . . as circuits of the ASIC 126. The aforementioned catch and centering holes ensure position appropriate circuitry on both sides.

An injection-molded object 30a made of thermosets, in particular epoxy resin, surrounds, at least in part, the ASIC 26, the bond wires 28 and the conductor strands 20 as shown in FIG. 22. During injection, the frame 29a seals the injection mold and prevents the plastic from dissipating between the conductor strands. The ASIC 126, the bond wires 128 and the conductor strands 120 are enclosed with an injection molded body 130a on the opposite side in the same manner.

The components C1, C2, C3, C4 are encapsulated with an injection molded body 30b and the components C101, . . . with an injection molded body 130b that are made of thermosets as well. Here, frames 29b, . . . play the same role as the frames 29a, . . . when forming the injection molded body 30a, 130a.

A support body is injected together with the injection molded bodies 30a, 30b, 130a, 130b that embed conductor structures of several parallel webs on both sides. These extrusion coatings will also have special tasks when testing the almost finished double module unit.

Finally, all frames 18, 29a and 29b as well as 118 and remaining jumpers between the conductor strands 20, 120 are removed by punching. This punching procedure produces the final electrical circuit. The support function of terminals and conductor connections are taken over by the injection molded bodies 30a and 30b as well as 130a and 130b.

The finished double module unit 114, consisting of one or two ASICs or other integrated circuits and the components for the protective circuit and the like is then available with the respective housings.

In summary it can be stated that only two main materials are used for a cost-efficient and accurate production of a throttle valve device, namely
synthetics and
thin metal strips.

In this respect, throttle bodies can be formed of thermosets and thermoplastics in the form of cylinder bodies that can be manufactured easier and with greater fitting accuracy and that have higher usage value properties. Throttle valve bodies can be formed that can be adjusted in the throttle body in a position-accurate manner. A PTFE coating can be applied that ensures a problem-free movement of the new throttle valve in the throttle body.

Added are punched metal strip lead frames that can be populated with ASICs, components and the like to create a module or double module unit, whereby a connection grid element connects a sensor unit with a module or double module unit to an output unit suitable for assembly and installation.

What is claimed is:

1. A throttle valve device including at least one throttle body, a throttle valve and a throttle valve shaft, with which the throttle valve is arranged in the throttle body in a position-adjustable manner, the improvement wherein the throttle body is formed of an inner cylinder made of a hard, smooth material around which at least partially is formed an outer cylinder made of a thermoplastic.

2. A throttle valve device as set forth in claim 1, wherein the material is a non-metallic material selected from the group consisting of thermosets and a ceramic material.

3. A throttle valve device as set forth in claim 1, wherein the material is a metallic material selected from the group consisting of drawn aluminum, magnesium and an extruded material.

4. A throttle valve device as set forth in claim 1, wherein the thermoplastic is selected from the group consisting of PA (polyamides), PBTB (Polybutylene terephtalate), PPS (polyphenylene sulfide), POM (Polyoxymethylene), aliphatic polyketones, PVDF, a polyelefine, such as PE (polyethylene), HDPE (high density polyethylene), PP (polypropylene) and mixed polymerisates selected from the group consisting of TEE, TPE, PPA and PEEK (polyetheretherketone).

5. A throttle valve device as set forth in claim 1, wherein the cylindrical hollow body is produced as a drawn precision tube.

6. A throttle valve device as set forth in claim 1, wherein the throttle valve comprises a center thermoset element that is surrounded at least in part by a thermoplastic enclosure body.

7. A throttle valve device as set forth in claim 1, wherein the throttle valve comprises a central thermoset element that is surrounded all around at least in part by a thermoplastic enclosure body.

8. A throttle valve device as set forth in claim 1, wherein the inner cylinder is provided at least in part with a flat section.

9. A throttle valve device as set forth in claim 1, wherein the inner cylinder is surrounded at least in part by a fin section.

10. A throttle valve device as set forth in claim 1, wherein the inner cylinder is provided at least in part with an inner coating.

11. A throttle valve device as set forth in claim 1, wherein the inner cylinder is separated at the level of the throttle valve shaft.

12. A throttle valve device as set forth in claim 1, wherein the inner cylinder is separated into an upper and a lower partial cylinder.

13. A throttle valve device as set forth in claim 1, wherein the inner cylinder is separated into a left and a right partial cylinder.

14. A throttle valve device as set forth in claim 10, wherein the inner coating is made at least in part of PTFE (trade name Teflon).

15. A throttle valve device as set forth in claim 1, wherein the throttle valve shaft exhibits at least one catch element by which the throttle valve shaft is connected to the throttle valve.

16. A throttle valve device as set forth in claim 15, wherein the catch element is a catch body.

17. A throttle valve device as set forth in claim 15, wherein the catch element is a toothed element.

18. A throttle valve device as set forth in claim 1, wherein an inner thermoplastic body serving as a thermoplastic enclosure body is arranged on a central body element of the throttle valve.

19. A throttle valve device as set forth in claim 1, wherein an inner thermoplastic outer body is arranged on a central body element of the throttle valve and opposite the thermoplastic inner body.

20. A throttle valve device as set forth in claim 1, wherein the throttle valve shaft is supported by at least one of sliding and ball bearings.

21. A throttle valve device as set forth in claim 1, wherein a housing is molded on and connected with an outer cylinder hollow body made of a thermoplastic.

22. A throttle valve device as set forth in claim 21, wherein a measuring and relocating device is arranged in the housing, where a sensor unit and an output unit is connected through a connection grid element that includes at least one grid rail.

23. A throttle valve device as set forth in claim 22, wherein the sensor unit includes a module unit, where an integrated circuit is located on an sub-area of a conductive board and is encapsulated by an injection molded body, and wherein the integrated circuit is connected via conductor strands to components that are encapsulated by an additional injection molded body.

24. A throttle valve device as set forth in claim 1, wherein the sensor unit includes a double module unit, and wherein a conductive board includes an upper and a lower subarea,
whereby a first integrated circuit is arranged on the upper sub-area and is encapsulated by a first injection molded body,
whereby the first integrated circuit is connected via first conductor strands to first components that are encapsulated by a second injection molded body,
whereby a second integrated circuit is arranged on the lower sub-area that is encapsulated by a third injection molded body, and
whereby the second integrated circuit is connected via second conductor strands to second components that are encapsulated by a fourth injection molded body.

25. A throttle valve device as set forth in claim 1, wherein the inner cylinder is separated into an upper and a lower partial cylinder.

26. A throttle valve device as set forth in claim 1, wherein the inner cylinder is separated into a left and a right partial cylinder.

27. A throttle valve device as set forth in claim 1, wherein the inner cylinder is separated in the area of the shaft element.

28. A throttle valve device as set forth in claim 1, wherein at least one of the sliding and ball bearings are at least partially enclosed by bearing enclosure areas of the outer cylinder made of a thermoplastic.

29. A method for producing a throttle valve device comprising at least
a throttle body,
a throttle valve, and
a throttle valve shaft with which the throttle valve is adjustably positioned in the throttle body, said method comprising the steps of:
a) forming of an inner cylinder with at least one flat section and at least one fin element made of a hard, smooth material;
b) molding in at least one of sliding and ball bearings when forming the inner cylinder;
c) extrusion-coating of the inner cylinder with an outer cylinder made of a thermoplastic and at least partially enclosing of at least one of the sliding and ball bearings with bearing enclosure areas.

30. A method for producing a throttle valve device comprising at least
a throttle body,
a throttle valve, and
a throttle valve shaft with which the throttle valve is adjustably positioned in the throttle body, said method comprising the steps of:
a) forming of two partial inner cylinders made of a hard, smooth material with at least one flat section and at least one fin element;
b) putting at least one of the sliding and ball bearings onto the throttle valve shaft;
c) putting together the two partial inner cylinders enclosing at least one of the sliding and ball bearings with the two partial inner cylinders,
d) extrusion-coating of the upper and lower partial inner cylinder with an outer cylinder made of a thermoplastic and at least partially enclosing of at least one of the sliding and ball bearings with bearing enclosure areas.

31. A throttle valve device comprising at least
a throttle body,
a throttle valve, and
a throttle valve shaft with which the throttle valve is adjustably positioned in the throttle body, wherein
a) two partial inner cylinders made of thermosets are formed with at least one flat section and at least one fin element,
b) at least one of sliding and ball bearings are put onto the throttle valve shaft,
c) the two partial inner cylinders are placed together and the sliding and ball bearings of the throttle valve shaft placed between them are enclosed by the two partial inner cylinders,
d) the two partial inner cylinders are extrusion-coated with an outer cylinder made of a thermoplastic and the sliding and ball bearings are at least partially enclosed with bearing enclosure areas.

32. A throttle valve device as set forth in claim 31, wherein a housing bottom is molded on when forming the hollow outer cylinder body.

33. A throttle valve device as set forth in claim 4, wherein the polyelefine is selected from the group consisting of PE (polyethylene), HDPE (high density polyethylene).
